(19) United States
(12) Patent Application Publication
(10) Pub. No.: US 2016/0165104 A1
(43) Pub. Date: Jun. 9, 2016

(54) LOCALIZED BRIGHT SOURCE SUPPRESSION

(71) Applicant: Garth W. Gobeli, Albuquerque, NM (US)

(72) Inventor: Garth W. Gobeli, Albuquerque, NM (US)

(21) Appl. No.: 14/223,529

(22) Filed: Mar. 24, 2014

(51) Int. Cl. H04N 5/225; H04N 7/18

(52) U.S. Cl. CPC H04N 5/2254; H04N 5/2253; H04N 7/18

(57) ABSTRACT

This invention discloses an apparatus and a method of use that permits localized bright sources in the field of view of night vision devices to be selective attenuated. This makes possible the observation of all objects in the device field of view regardless of their relative brightness. The invention results in a compact, lightweight, and low power addition to existing night vision devices that can be contained inside existing devices without modifying the case dimensions. The modified devices use a CCD camera display as the viewable output. The necessary parts to effect this conversion of existing devices can be furnished as a retro-fit kit.

### FIELD OF THE INVENTION

This invention relates to night vision devices (NVDs) that permit observations of scenes at nighttime or under other conditions of very low light levels. It reveals an apparatus and a method of use that permits localized very bright sources to be suppressed in the field of view (FOV) of NVDs so that all objects in the field of view can be simultaneously observed. It applies specifically to the class of portable hand held NVDs but can have additional applications.

### BACKGROUND OF THE INVENTION

NVDs that are used by individuals are compact, battery powered, and light enough to be easily and widely deployed for use in the field, both by military and civilians. They are passive instruments, using an image intensifier tube (IIT) to greatly increase the effectiveness of nighttime image amplification.

When a scene includes a localized bright source the amplified image of that source completely dominates the NVD performance such that information about other, dimmer objects cannot be observed. Such sources lead to overload of both the photocathode and the output phosphor of these instruments. Such overload can be suppressed by rapidly gating the tube voltage so that total anode current is contained within a value that will not damage the NVD.

This feature of NVDs is designated as “auto gating”. U.S. Pat. No. 6,087,649 describes a method for rapid auto gating via pulse-width-modification of the voltage applied to the photocathode of an NVD device. This insures that the total anode phosphor current is maintained at a safe value that prevents damage to the NVD. Such auto gated NVDs are of great assistance to aircraft pilots, especially while landing or taking off at night. While the bright source(s) in the field of view are readily observed the dimmer objects cannot be observed since their images have been suppressed by the same auto gating function as the brightest sources.

U.S. Pat. No. 5,729,010 describes a number of approaches to localized suppression of bright sources in the FOV of NVDs. Their apparatus is comprised of three components.

First: A spatial light modulator comprised of a Liquid Crystal Device (LCD) array is sandwiched between two polarizing plates and positioned immediately in front of the Image Intensifier (IIT) photocathode of the NVD. If the front window of an image intensifier tube is a fiber optic plate, the spatial light modulator is effectively immediately adjacent to the semi transparent photocathode. Thus it is “proximity focused”. Proximity focusing is the condition of extremely close physical contact so that the details of an image are not compromised in the transmission between the two objects.

For most modern manufactured NVDs the front window of the image intensifier tube is a single element of a transparent glass, usually borosilicate glass or fused quartz. For these NVDs the focus position is inside the window and onto the photocathode that is deposited on the inside face of this window.

Second: An active “retina” detector array is used to analyze the scene contents and to derive the information required to identify the pixels corresponding to “bright sources” in the NVD field of view (FOV). The composition of this “retina” display is not further described in this patent. This information is passed to the polarizer/LCD/analyzer assembly in front of the NVD photocathode and an electronic circuit commands a reduction of transmission through the LCD assembly for those selected pixel(s).

Third: A second channel display then provides the processed image of the scene in which the bright source has been greatly attenuated or removed from the field of view.

This patent discloses five suggested methods of achieving the objective of localized bright source masking in NVDs. All active suppression modes depend on the use of two channels of image processing and image observation.

This patent applies to NVDs that are specifically and newly manufactured to effect the localized source/object compensation described therein.

### SUMMARY OF THE INVENTION

The present invention provides a method of retrofitting existing NVDs, especially GEN II and GEN III units, so that they can observe dim objects in their FOV when one or more very bright sources/objects are also in the FOV. This method explicitly uses a single channel of image capture to effect the bright source suppression in modified night vision devices and to provide the observation of the field of view via a CCD camera and a miniature display.

It is an object to provide a spatially selective input scene attenuator for NVDs that is compact enough that existing NVDs can be retrofitted with the components while permitting such components to be incorporated into the original device case.

It is an additional object of the invention to provide a spatial light modulator (SLM) for providing such spatially selective filtering at the input of the NVD by using the polarizer-LCD array-analyzer components of a small LCD display from which the back plane light guide has been removed.

It is an object of this invention to provide an industry standard tapered fiber optic plate (Tapered-FOP) that is fabricated to couple the output Tapered-FOP of the existing NVD precisely to a ⅓ inch CCD chip of a board level CCD camera. Such Tapered-FOP are routinely made for several input face diameters, e.g. 16 mm, 22 m, 37 mm, 50 mm, etc.

It is an object of this invention to provide a small (1.44″ to 2.5″) LCD display that is mounted on the opposite side of the camera board from the CCD chip. This item provides the scene display that is viewed by the NVD user by original NVD eyepiece that is simply adjusted for a slightly different image focus.

It is the object of this invention to provide a small fast and compact electronic assembly to identify the input scene pixel (or pixels) that are to be selective attenuated by the SLM that is placed immediately in front of the NVD input fiber optic plate. One approach to this task would be for example to use a Field Programmable Gate Array (FPGA) as the control electronics.

It is an object of this invention to assembly the necessary optical components, the SLM and the CCD chip, to the IIT of the NVD by “proximity focusing”. That is by intimate contact to the IIT as opposed to using lenses or mirrors.

It is an object of this invention to use an electronic design approach for such required additional components such that the additional battery power required is minimal. Thus the new battery power requirement does not significantly shorten the operational NVD lifetime between battery recharges.

It is an object of this invention to provide an inexpensive method of providing the scene-selective localized attenuation of bright sources/objects that can be incorporated into many types of NVDs, in addition to the hand held instruments that used as the example here.

It is the object of this invention to provide for a zoom lens as the objective so that this feature can be incorporated into the modified NVD to readily improve apparent object resolution that will enhance usage of the instrument.

### BRIEF DESCRIPTION OF THE DRAWINGS

FIG. 1 shows the problem in using the NVF to observe objects in the GOV when a very bright object is also in the FOV.

FIG. 2 shows how the application of this invention permits all objects in the FOV to be observed, regardless of their relative brightness.

FIG. 3 shows the internal components of a standard unmodified NVD that uses a fiber optic plate as the input (object) window.

FIG. 4 shows the internal components of a standard unmodified NVD that uses a quartz or glass plate as the input (object) window.

FIG. 5 shows the NVD of FIG. 3 that has a fiber optic input window with the additional optical and electronic components for implementing the localized scene attenuation of bright sources/objects.

FIG. 6 shows the modified NVD of FIG. 4 with a plane glass input window with a zoom lens that replaces the standard objective lens.

FIG. 7 shows the modified NVD of FIG. 6 with a telephoto lens replacing the standard objective lens.

FIG. 8 shows a small, short addition to the standard NVD eyepiece region that provides room for additional electronic circuits and additional batteries (if required) for certain NVDs.

### DETAILED DESCRIPTION OF THE INVENTION

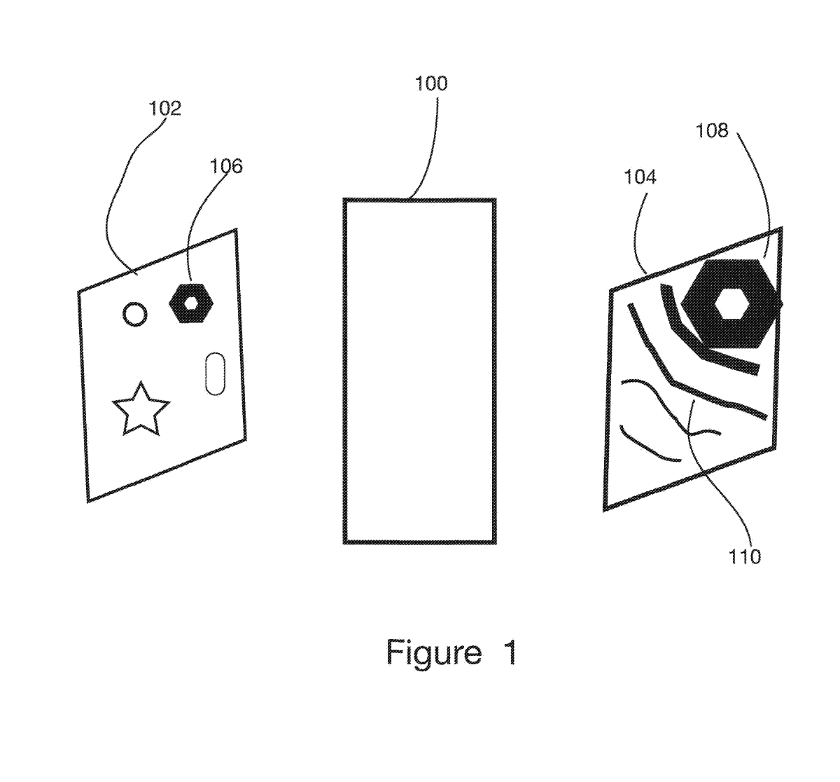

FIG. 1 illustrates the observed results when a standard NVD (100) observes a scene (102) that contains a very bright light source (106). Since the entire NVD has only one overall gain, the bright source dominates the scene to the point that the observation (104) is completely over written by the amplified bright source (108) and the effects of overwhelming the photocathode response characteristic. This results in an overexposed scene that has “bloomed” so that no other objects in the scene can be identified. Since this uncontrolled “blooming” in the NVD can damage internal parts of the image intensifier tube the method of “auto gating” of the tube power supply to limit the overall current that can be drawn by the tube was instigated.

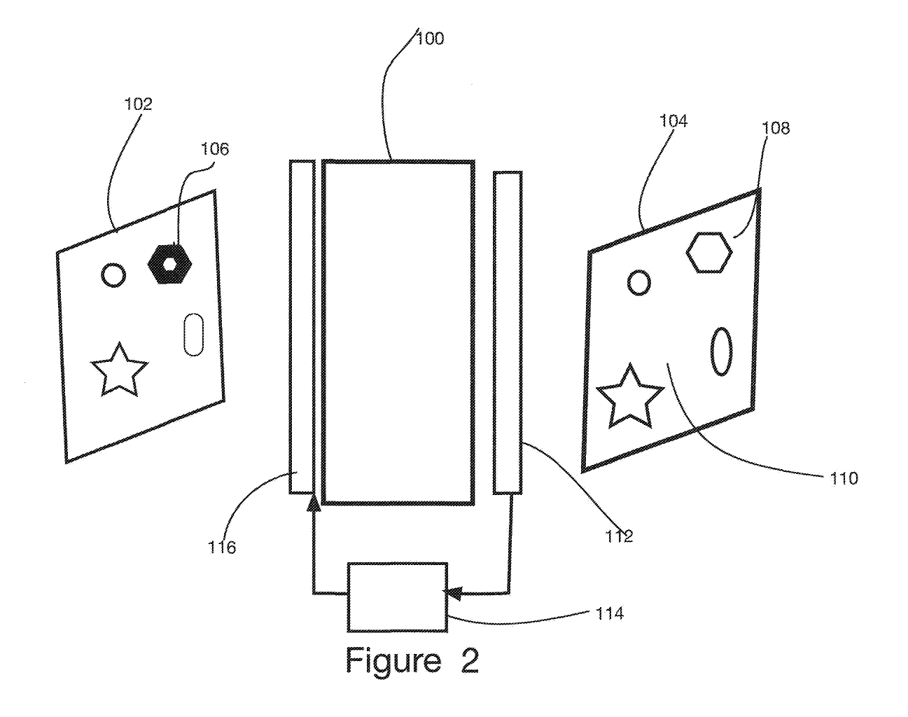

FIG. 2 shows the results of observing the same scene (102) containing the same bright source (106), but now the NVD (100) has been modified by the method called out in this invention. A modified LCD display (112) detects the pixel(s) location of the bright source and by electronic circuit (114) a dimming command is sent to a spatial light modulator (SLM) (116) to provide a signal that selectively darkens the proper pixels of the SLM. This substantially attenuates the localized light from the bright source that reaches the photocathode of the NVD. Thus the observed scene (104) can now show all objects in the FOV, including the attenuated image of the bright source (108).

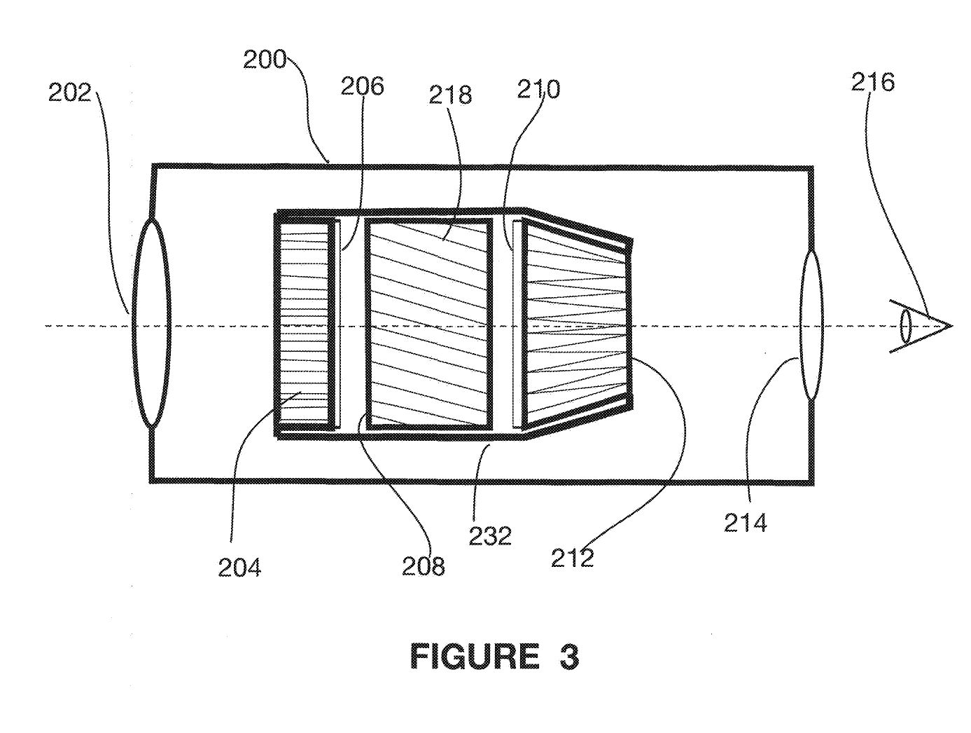

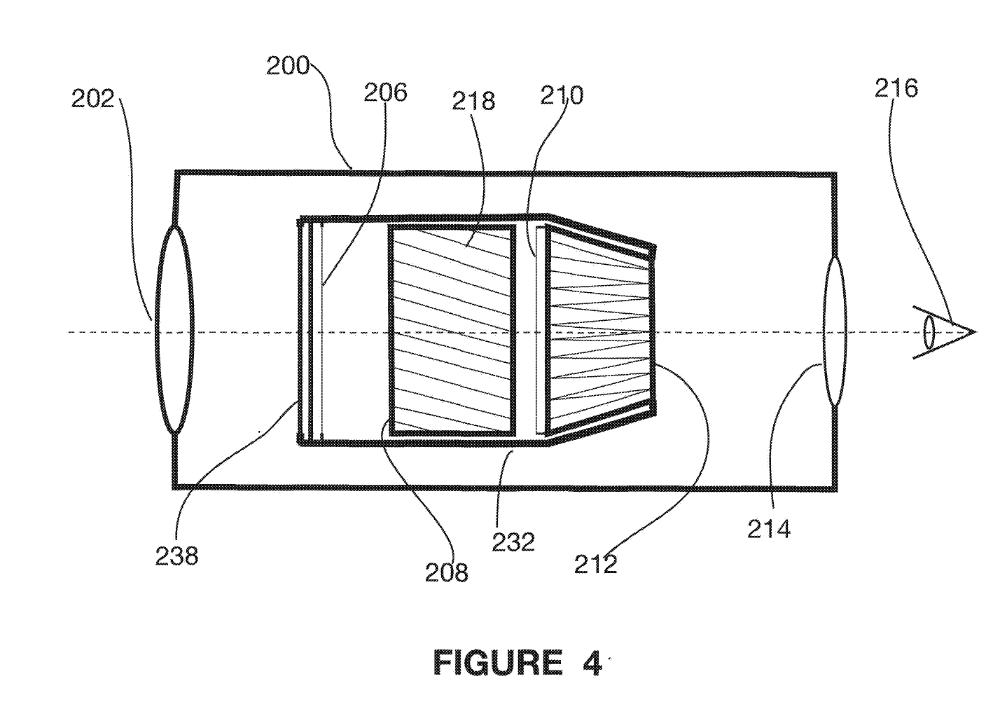

FIG. 3 shows a diagram of the inner workings of a typical GEN II and/or GEN III NVD (200). The distant scene to be displayed is imaged by an objective lens (202) onto the front surface of a fiber optic window (204) of the IIT (218). The image is transmitted by the fibers of the input window FOP to output face, which is coated with a semi transparent photocathode (206) of the IIT. This design of the input to the micro channel plate is usually found on earlier manufactured devices. Current manufacture uses a single glass or quartz plate as the input window (Item 238 of FIG. 4).

This photocathode releases electrons, the local density of which correspond to the intensity variations of the image intensity. A voltage then accelerates these electrons between the photocathode (206) and the input face of a micro channel plate (MCP) (208). The electrons cascade through the small channels in the MCP and the hugely magnified electron current is ejected into the space between the MCP output face and the phosphor coated (210) screen. The NVD uses an output tapered fiber optic window (212). Some very high gain NVDs uses a two or three successive MCPs in series to greatly enhance the overall gain of the NVD. This bright source masking method outlined here will function well for these devices.

The space between the phosphor (206) and the input face of the MCP (108) is kept very short so that variations of the spatial information in the optical image on the photocathode (206) is preserved in the photoelectrons emitted by the photocathode to the MCP input face. This is known as “proximity focusing”.

Similarly, the spacing between the MCP output face and the NVD output phosphor (210) is kept small and the electron density image is then converted to the FOV amplified optical image. The optical image is transmitted by a tapered fiber optic (FOP) window (212) to provide a reduced size optical image that can be readily observed by a user's eye (216) via a convenient size eyepiece lens (214).

The entire set of active components of the NVD is contained in an evacuated envelope (232). The objective lens (202), and the eyepiece lens (214), as well as a battery for powering the instrument are contained inside the case (200).

Auto gated NVDs, described earlier, limit total cathode and anode current to accommodate to potential bright light overload so as to safeguard the optical-electronic structures of the NVD. This approach does not permit observation of other lesser bright objects in the field of view.

FIG. 4 shows the NVD that uses a flat glass or quartz window (238) as input to the NVD. The scene is focused on the photocathode (206) that is deposited on the inside of the window. Otherwise the NVD performs as discussed above.

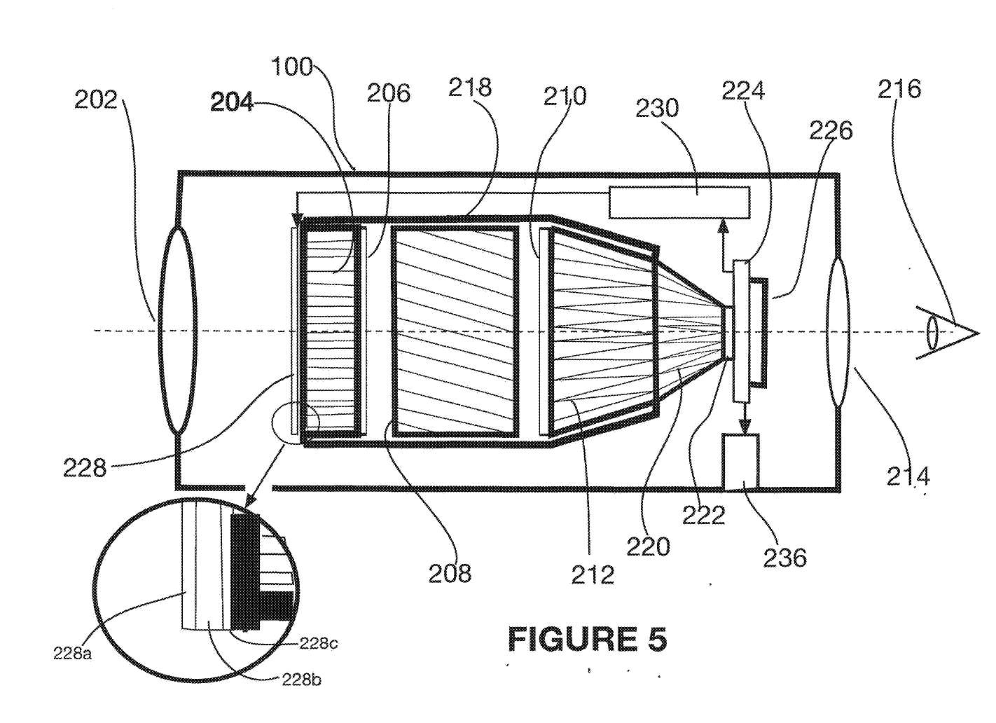

FIG. 5 shows a diagram of the NVD that has the electronic/optical components included to effect the localized bright source/object suppression in the FOV. This localized suppression operates to permit complete study of all objects in the FOV, regardless of their relative brightness. FIG. 5 is representative of early NVD manufacture. The elements of the unmodified NVD of FIG. 3 are reproduced in FIG. 5 with the same reference numbers.

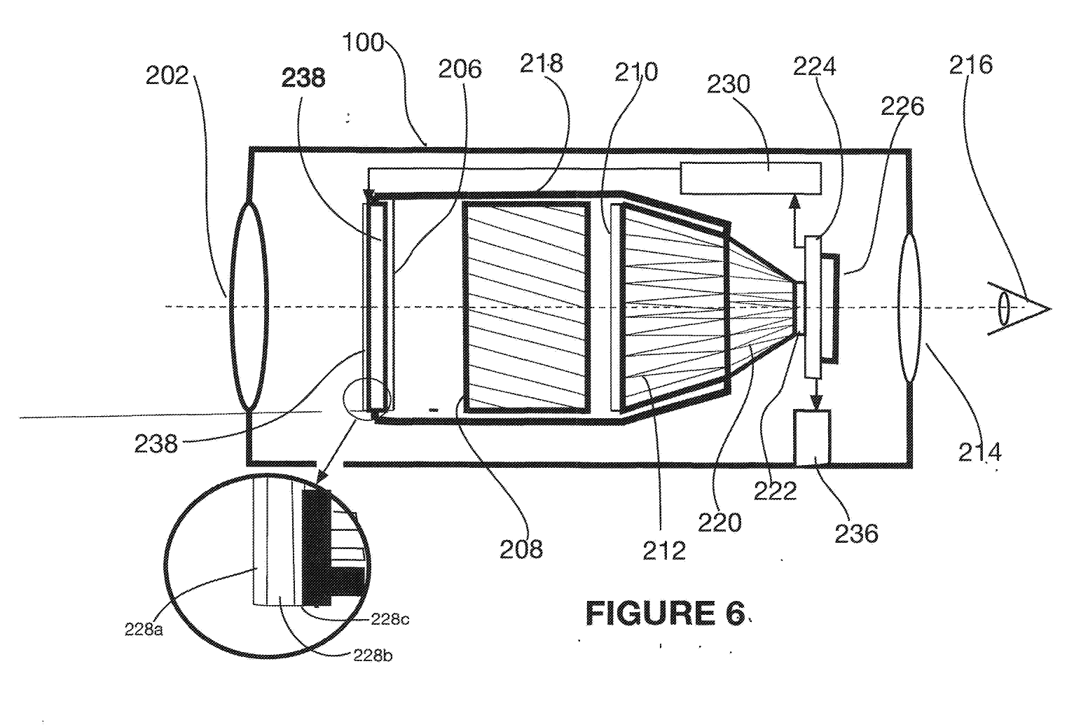

FIG. 6 shows the same modifications of the NVD with the plane glass or quartz input window usually used in current tube manufacture.

An auxiliary output tapered FOP (120) is positioned in contact with the NVD tapered fiber optic output widow in order to optimize the Modified-NVD output to a ⅔ inch CCD camera chip (122). There are a number of such FOPs available to couple a variety of NVD output formats to the standard ⅔ inch CCD camera chip. For example coupling from 16 mm, 23 mm, or 32 mm diameter input sizes to the ⅔ inch CCD format are commercially available. Such tapered FOPs are about 20 mm long and do not add significantly to NDV overall length.

The CCD camera chip is part of a board level CCD camera (124) that has a board dimension of about 37 mm×37 mm and an overall thickness of about 6 mm. Note that the lens of the board level camera has been removed and image focus on the chip is achieved by proximity focusing.

A small LCD display unit (126) is bonded to the back surface of the camera board and presents the Mod-NVD output for viewing by the observer (116) via an adjustable focus eyepiece (114). Again, the thickness of this small LCD display is only 2-3 mm and thus the overall length of the output modification components is less than 19 mm (about ¾ inch).

The output of the camera chip (122) is routed both to the viewing LCD display (126) and an electronic logic and control circuit (130), which can be a field programmable gate array (FPGA). FPGAs are very fast and very compact logic circuits that permit the necessary logical determination of the pixel locations of the bright source/objects in the NVD FOV, and will partially obscure those pixels only via the liquid crystal SLM (118).

In FIG. 5, the elements of the SLM (118) are shown in the exploded view as a first polarizing element (118a), a liquid crystal array of optical switches (118b) sandwiched between the first polarizing element (118a) and the analyzer element (118c). A suitable voltage applied to the LCD layer (118b) will cause the entire SLM to provide maximum optical transmission. This state is the maximum transmission reference state of the modified NVD state.

When the electronic package detects that one or more pixels of the CCD camera responds to a bright source/object such that the pixel reaches a full element value in excess of a predetermined level, for example, a value greater than 127 of a possible 255 amplitude, the voltage for that pixel(s) is reduced by a factor of 2 so that the new brightness value cannot exceed the 127 value rather than the earlier maximum value of 255. This monitoring/control procedure is rapidly repeated so that the value of the bright source/object image is permitted only a maximum value of, for example, 127/255 regardless of the true intrinsic brightness value. This procedure permits the NVD to react properly to transient large intensity changes such a muzzle flashes from gunfire, momentary reflected light intensity excursions, etc. The maximum contrast attenuation available from such LCVD elements is a factor of at least 30 or more.

When the identified source brightness changes to a value below a selected value, for example, such as 63/255, then the voltage changes so as to permit an increase in the permitted value to 127/255. This decline of brightness tracking feature is similar to the increasing brightness reaction discussed in detail above.

The electronic package reacts rapidly enough that the intensity of several different bright sources/objects can simultaneously be processed to effect the scene control.

Similarly, motion of the bright source/object(s) in the field of view can be racked when ever they move within the FOV, regardless if that motion is due to actual movement of the source or motion caused by the motion of the hand held device. Either of these types of motion in the observed scene is readily tracked by the very fast FPGA electronics and the object brightness is readily compensated for.

Since the output of the modified NVD is now via a CCD camera chip, the observed scene can be permanently stored on a small compact USB memory stick. Provision for this data storage can be provided by incorporation of a SD card output port for the NVD, [236 in FIG. 5]. The images can be stored as snapshots that are selected by the user or by continuous streaming of the CCD camera output.

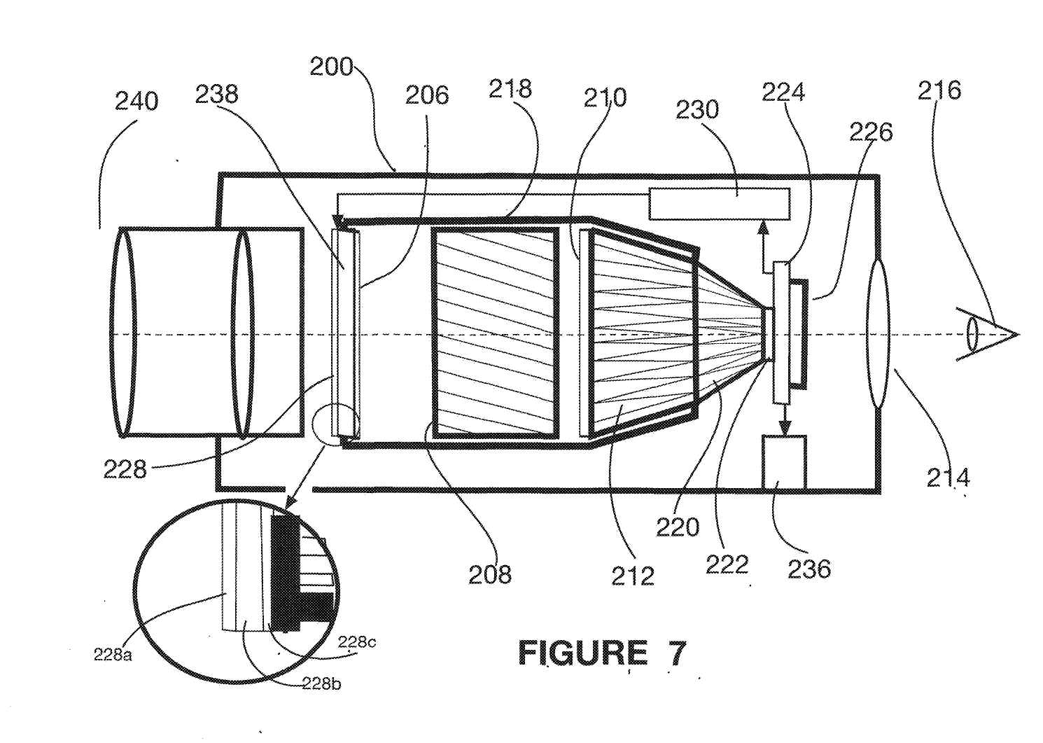

FIG. 7 shows that the modified NVD can readily be adapted to use a zoom camera lens since the display is provided by an LCD display (224). Thus a standard camera zoom lens (240) is shown as replacing the original objective lens (202) of the NVD.

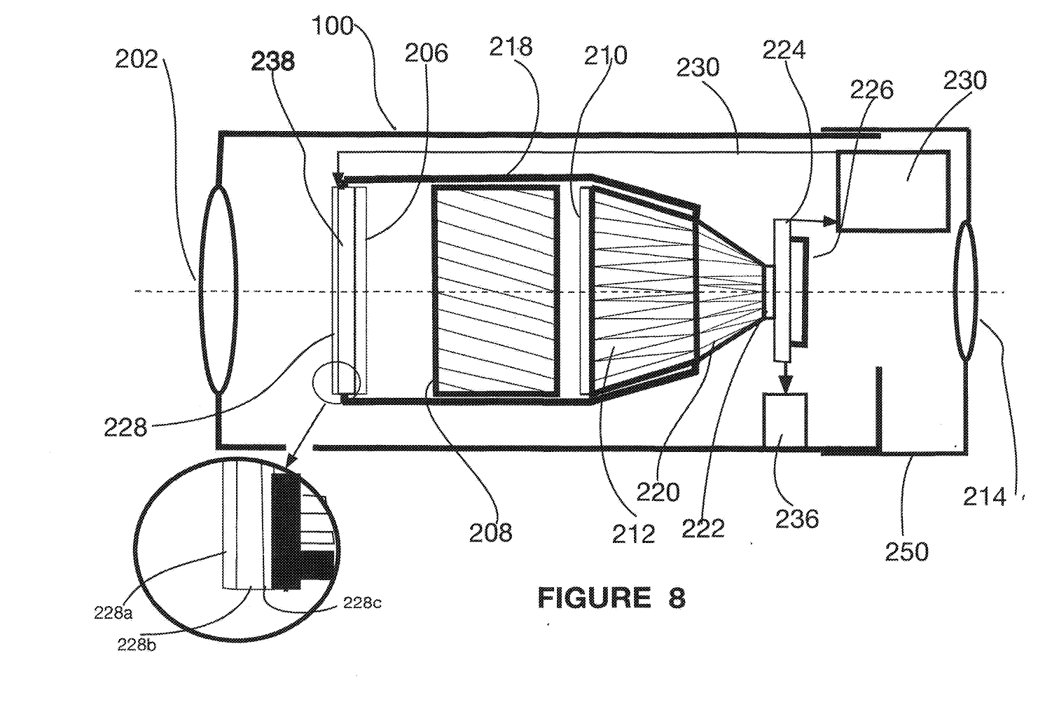

FIG. 8 illustrates how a small added “cap” (250) at the output face of the Mod-NVD can be used for some devices that configured such that the electronic circuits (230) cannot be contained inside the original NVD case. This “cap” is of the order of 25 mm or less and does not significantly impact the NVD profile.

A major feature of this “retro-fit” approach is that it uses a single channel both for generating signals to the SLM and to provide a view of the scene.

The above-described new components can be assembled to form a “retro fit kit” and can be furnished as such to permit the upgrade retrofit for NVDs already in the field.

Clearly, a newly manufactured NVD can be designed to incorporate the components described in this invention and it will function as described here.

The retrofitted NVD is used to look at a very dimly lit scene. It will black out only bright sources that are contained in the field of view. This permits all other objects of lesser brightness to be clearly observed.

Electronic zoom can be used to enlarge the image presented to the output LCD display (226). This zoom feature can provide a rapid and convenient study of a designated feature in the field of view.

1. A method for retrofitting a night vision device comprising the steps of:
opening up the case of a night vision device;
inserting a tapered fiber optic which is in close contact to the night vision device output window such that it is proximity-focused to the night vision output fiber optic;
the new output tapered fiber optic window is formatted to couple efficiently to a ⅔ inch CCD camera chip and proximity focused on the CCD camera chip;
inserting a small board level camera with lens removed and with the CCD camera chip in close contact with the output end of the added tapered fiber optic such that is proximity focused onto the CCD camera chip;
securing a small LCD TV display to the outward facing surface of the board-level camera so that it acts as the scene viewing device for the modified night vision device;
routing the output of the board level CCD camera to this small LCD display;
adjusting the eyepiece lens so that the small output LCD display is in focus;
using an objective lens to focus the scene on the photocathode of the image intensifier tube of the night vision device;
positioning an LCD spatial light modulator in close contact with the input fiber optic window of the night vision device such that it is proximity focused;
said spatial light modulator being comprised of a liquid crystal device array that is positioned between a first polarizer, and a second polarizer, (the analyzer);
when a suitable voltage is applied some of the LCD array elements of the light transmitted by those elements are controlled;
inserting a suitable electronic circuit inside the night vision device case that provides the information derived from the CCD camera to the spatial light modulator;
the light transmission of the cells being addressed of the spatial light modulator can be partially obscured over a range of at least 30 to 1 or more relative to unaddressed cells;
the CCD camera provides video output to a USB port that permits selected frames of the NVD to be permanently saved to a USB memory stick;
all control and viewing functions are carried out in a single channel.

2. A method for retro-fitting a night vision device according to claim 1, wherein said electronic circuit can be an electronic circuit such as a field programmable gate array (FPGA) or other types.

3. A method for retro-fitting a night vision device according to claim 1, in which the fixed-focus objective lens is replaced by a variable focus “zoom” lens.

4. A method for retro-fitting a night vision device according to claim 1, wherein a small, short extension of the night vision device case at the eyepiece lens position can provide space for enclosing the electronic package for some types of compact night vision devices.

5. A method for retro-fitting a night vision device according to claim 1 that provides an SD card to be connected to the CCD camera that will permit selected frames of the NVD to be permanently recorded and stored when desired.

6. A method for retro-fitting a night vision device according to claim 1 that applies to night vision devices that use more that one image intensifier micro channel plate in series for significantly enhancing the overall optical gain of the instrument.

7. A method of providing a night vision device according to claim 1 that is entirely of original manufacture.

8. A method of providing a night vision device according to claim 1 that can be used for night vision devices manufactured with either an input window of fiber optic plate or of single glass or quartz plate.

9. A light compensating night vision device comprising:
a case that contains the components of the modified night vision device;
an image intensifier tube that amplifies the low level night light of the scene to be examined;
an objective lens that images the scene to be examined onto the input fiber optic window of the image intensifier tube;
the image intensifier tube being one of a standard manufacture for current night vision devices;
the image intensifier tube being a one stage, two stage, or three stage sequential micro-channel plate formation;
the output of the micro-channel electron distribution is incident on a phosphor screen so that a greatly amplified optical image of the scene appears on the phosphor;
the output window of this phosphor screen is transmitted via a second fiber optic window that is usually tapered to create a reduced size image of the phosphor output;
this image is transferred via a second tapered output fiber optic to a board level ⅔ inch CCD camera;
this camera has its lens removed so that the second output tapered fiber optic is mated efficiently to the ⅔ inch format of the camera CCD chip;
the output of the board level camera is routed to a small LCD display that is secured to the face of the board level camera opposite to the CCD chip;
this LCD display forms the output image of the night vision device that is observed via an eyepiece;
the output of the CCD camera chip is also sent to an electronic package, such as a field programmable gate array or other suitable electronic circuit;
this electronic circuit is programmed to detect when a pixel or set of localized pixels is out-of-range for the display;
this circuit controls the local brightness of the image at the NVD input window by acting on a spatial light modulator that is positioned in front of the NVD input window;
the spatial light modulator is placed in proximity focus with the NVD input fiber optic window;
the spatial light modulator is formed by a liquid crystal device array of cells that is positioned between two polarizers;
the electronic circuit provides the addresses of the pixels of the spatial light modulator that must be attenuated and by how much each pixel must be attenuated;
the electronic circuit is furnished a map of which pixels in the CCD camera relate to particular pixels of the spatial light modulator.

10. The apparatus described in claim 9 with the fixed focus objective is replaced by a camera variable focus zoom lens.

11. The apparatus described in claim 9 that has an SD card connected to the CCD camera so that selected frames of the CCD camera can be permanently recorded and saved when desired.

12. The apparatus described in claim 9 that has an extended cap placed over the output end of the night vision device so that room is provided for the additional electronic and optical components needed to effect the retro-fit.

13. The application of this method of localized bright source suppression to visible and infrared cameras that are used for surveillance purposes.
